(19) United States
(12) Patent Application Publication
(10) Pub. No.: US 2018/0247498 A1
(43) Pub. Date: Aug. 30, 2018

(54) DETERMINING WHAT THE INDICATORS REPRESENT ON A SECURITY DEVICE

(71) Applicant: ADT US HOLDINGS, INC., Boca Raton, FL (US)

(72) Inventors: Gary FRIAR, Saint Cloud, FL (US); Tim RADER, Lake Worth, FL (US); Michael GARAVUSO, Boynton Beach, FL (US)

(21) Appl. No.: 15/903,805

(22) Filed: Feb. 23, 2018

Related U.S. Application Data
(60) Provisional application No. 62/463,190, filed on Feb. 24, 2017.

(51) Int. Cl. G08B 7/06; G08B 5/38; H04B 10/116; H04M 1/725

(52) U.S. Cl. CPC G08B 7/06; H04M 1/72527; H04B 10/116; G08B 5/38

(57) ABSTRACT

A device, server and methods for translating captured media of a premises device. A device is provided. The device includes processing circuitry configured to capture media of a premises device in the premises system where the captured media indicates at least one of a status and diagnostic information associated with the premises device. The processing circuitry is further configured to, if the captured media matches at least one predefined criterion: output at least one of an audio and visual translation of the captured media.

### CROSS-REFERENCE TO RELATED APPLICATION

This Application is related to and claims priority to U.S. Provisional Patent Application No. 62/463,190, entitled “DETERMINING WHAT THE INDICATORS REPRESENT ON A SECURITY DEVICE,” filed Feb. 24, 2017, the entirety of which is incorporated herein by reference.

### TECHNICAL FIELD

This disclosure relates to a method, device and system for a premises system, and in particular to translation of media output of a premises devices.

### BACKGROUND

The demand for systems that monitor homes and businesses for alarm conditions has continued to grow as more home and business owners seek to protect their premises from various hazards and threats. Examples include intrusion, fire, carbon monoxide and flooding, among others dangers that may be monitored and reported to a monitoring station. When a sensor such as a motion detector is triggered, a representative at a remote monitoring center receives an alarm event code and initiates a response process, including contacting a homeowner or others on a contact list and/or first responders such as local firefighters and/or police to request a dispatch to investigate the event at the premises being monitored. These systems further extend into the home automation field by monitoring and controlling home automation based devices in and around a premises. Examples include monitoring and/or controlling a thermostat, lighting, appliances, etc.

However, these premises devices typically do not include displays for displaying statuses, configurations and/or other information. In particular, these premises devices tend to have one or more LEDs that provide status and/or diagnostic information to the customer, installer or the service technician. However, most of the information from the LEDs are not readily understood by anyone because they do not understand the meaning of the LEDs. Even if a display is included on the premises device, the readout of the diagnostic information is very limited and cryptic such that deciphering the information is difficult, especially for the average person with little technical background.

### SUMMARY

Some embodiments advantageously provide a method, device and system for a premises system, and in particular to a translation of media output of a premises devices.

According to one aspect of the invention, a device for translating captured media of a premises device is provided. The device includes processing circuitry configured to capture media of a premises device in the premises system where the captured media indicates at least one of a status and diagnostic information associated with the premises device. The processing circuitry is further configured to, if the captured media matches at least one predefined criterion, output at least one of an audio and visual translation of the captured media.

According to one embodiment of this aspect, the at least one predefined criterion is at least one of a media sequence and media pattern. According to one embodiment of this aspect, the media sequence is generated by a light emitting diode (LED) of the premises device. According to one embodiment of this aspect, the captured media corresponds to a plurality of visual sequences emitted by the premises device. The output of at least one of the audio and visual translation of the captured media includes respective translations for each of the plurality of visual sequences.

According to one embodiment of this aspect, the captured media corresponds to a plurality of visual sequences emitted by the premises device. The output of at least one of the audio and visual translation of the captured media includes a translation based on the plurality of visual sequences. According to one embodiment of this aspect, the visual translation includes textual information based at least in part on at least one of the status and diagnostic information that is indicated in the captured media. According to one embodiment of this aspect, the visual translation includes troubleshooting information based at least in part on at least one of the status and diagnostic information that is indicated in the captured media.

According to one embodiment of this aspect, the premises system is a premises security system and the premises device is a device used for monitoring a premises associated with the premises security system. According to one embodiment of this aspect, the output of at least one of audio translation and visual translation of the captured media includes at least one of displaying the visual translation on a display of the device and outputting the audio translation via a speaker of the device.

According to another aspect of the invention, a method for a device for translating captured media of a premises device is provided. Media of a premises device in the premises system is captured. The captured media indicates at least one of a status and diagnostic information associated with the premises device. If the captured media matches at least one predefined criterion, at least one of an audio and visual translation of the captured media is output.

According to one embodiment of this aspect, the at least one predefined criterion is at least one of a media sequence and media pattern. According to one embodiment of this aspect, the media sequence is generated by a light emitting diode (LED) of the premises device. According to one embodiment of this aspect, the captured media corresponds to a plurality of visual sequences emitted by the premises device. The output of at least one of the audio and visual translation of the captured media includes respective translations for each of the plurality of visual sequences.

According to one embodiment of this aspect, the captured media corresponds to a plurality of visual sequences emitted by the premises device. The output of at least one of the audio and visual translation of the captured media includes a translation based on the plurality of visual sequences. According to one embodiment of this aspect, the visual translation includes textual information based at least in part on at least one of the status and diagnostic information that is indicated in the captured media. According to one embodiment of this aspect, the visual translation includes troubleshooting information based at least in part on at least one of the status and diagnostic information that is indicated in the captured media.

According to one embodiment of this aspect, the premises system is a premises security system and the premises device is a device used for monitoring a premises associated with the premises security system. According to one embodiment of this aspect, the output of at least one of audio translation and visual translation of the captured media includes at least one of displaying the visual translation on a display of the device and outputting the audio translation via a speaker of the device.

According to another aspect of the invention, a server for translating captured media of a premises device is provided. The server includes processing circuitry configured to receive captured media corresponding to media output by the premises device associated with the premises system where the captured media being captured by a capture device and indicating at least one of a status and diagnostic information associated with the premises device, and if the captured media matches at least one predefined criterion, transmit a message to the capture device where the message indicating at least one of an audio and visual translation of the captured media and instructing the capture device to play the at least one of the audio and visual translation of the captured media. According to one embodiment of this aspect, the at least one predefined criterion is at least one of a media sequence and media pattern.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a block diagram of an exemplary premises system in accordance with principles of the invention;

FIG. 2 is a flow diagram of an exemplary translation process in accordance with the principles of the invention; and

FIG. 3 is a flow diagram of an exemplary analysis process in accordance with the principles of the invention.

### DETAILED DESCRIPTION

The instant disclosure solves the problems with existing systems by allowing a user to use a device such as a cell phone or mobile phone with video, image and/or audio capture capabilities to capture and translate LED color, blinking time and/or pattern to decode the status and diagnostics data indicated by the LED(s) or other media output devices of the premises device. In other words, media output of the premises device may be captured in accordance with the principles of the invention and the invention is not limited solely to the translating of LED patterns. For example, an audio pattern can also be captured for translation. Also, although the term “LED” is used herein, the invention is not limited to such. The term “LED” as used herein refers to any lighted indicator and can include liquid crystal display (LCD) indicators, incandescent indicator, neon indicators, visual indicators, etc. This status and diagnostics data/information can be translated and then presented to the user in an easy to understand and use format. In one embodiment, the captured status and diagnostic data can be transmitted to a third party for translation, interpretation and troubleshooting assistance. In one embodiment, the LEDs can be interpreted in real-time.

Before describing in detail exemplary embodiments that are in accordance with the disclosure, it is noted that the embodiments reside primarily in combinations of system/device components and processing steps related to translating media that is output by a premises device of a system such as a security and/or home automation system. Accordingly, components have been represented where appropriate by conventional symbols in drawings, showing only those specific details that are pertinent to understanding the embodiments of the disclosure so as not to obscure the disclosure with details that will be readily apparent to those of ordinary skill in the art having the benefit of the description herein.

As used herein, relational terms, such as “first,” “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

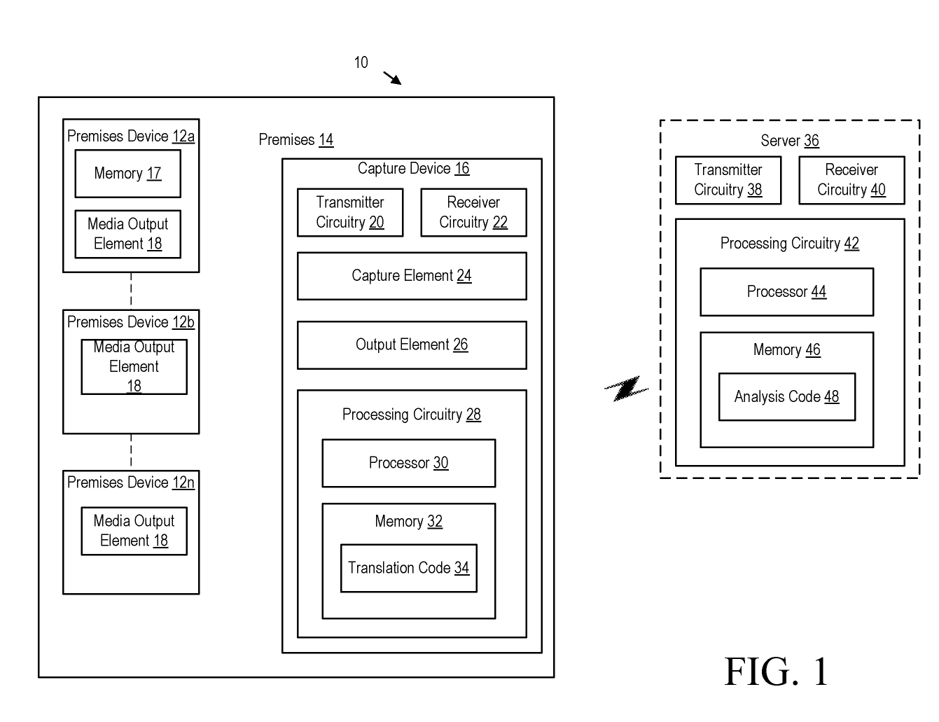

Referring now to drawing figures in which like reference designators refer to like elements there is shown in FIG. 1 an exemplary system for audio and/or visual translation of a status, configuration and/or other information of a premises device in accordance with the principles of the disclosure and designated generally as “10.” System 10 includes one or more premises devices 12a-n (collectively referred to as premises device 12) located within and/or around premises 14, and capture device 16 for translating media output sequences and/or patterns of premises device 12 as described herein. Premises devices 12 include one or more types of sensors, control and/or image capture devices. For example, the types of sensors may include various life safety related sensors such as motion detection sensors, fire detection sensors, carbon monoxide detection sensors, flooding detection sensors and contact sensors, among other sensor types that are known in the art. The control devices may include, for example, one or more life style related devices configured to adjust at least one premise setting such as lighting, temperature, energy usage, door lock and power settings, among other settings associated with the premise or devices on the premise. Image capture devices may include a digital camera and/or video camera, among other image captures devices that are well known in the art. Premises device 12 may communicate with a premises system controller (not shown) at the premises that monitors premises devices 12 via wired, proprietary wireless communication protocols and/or known communication protocols such as Wi-Fi. Premises device 12 may also be a cellular communicator that is part of or communicates with the premises system controller. The cellular communicator communicates with a remote monitoring station to provide event and alarm data.

Also, it is contemplated that the premises system controller can include the LEDs or other audio or video indicators that provide status information. Thus, the premises system controller can provide the same indicator functions described herein with reference to premises device 12. Those of ordinary skill in the art will also appreciate that various additional sensors and control and/or image capture devices may relate to life safety or life style depending on both what the sensors, control and image capture devices do and how these sensors, control and image devices are used at premises 14.

Premises device 12 includes memory 17 for storing one or more instructions and/or predefined data for triggering media output element 18. For example, in one or more embodiments, memory 17 includes instructions for triggering at least one media output element 18 of premises device 12 to output a predefined pattern in order to indicate a specific status, diagnostic information and/or other information of premises device 12, action required by a person to fix an issue with premises device 12 and/or to provide another indication related to premises device 12. Premises device 12 triggering LEDs, display, speaker, etc., to indicate one or more status, conditions and/or information of premises device 12 is known in the art and the mechanism for doing so will not be further discussed herein.

Premises device 12 includes media output element 18. Media output element 18 is configured to output at least one of an audio and visual media associated with an indication of at least one of a status, configuration and operation of the premises device 12, among other information related to premises device 12. In one or more embodiments, media output element 18 includes at least one light emitting diode (LED) configured to be triggered in a predefined manner by premises device 12 based on at least one of a status, configuration and operation of the premises device 12. For example, in one or more embodiments, media output element 18 includes two LEDs that are configured to be triggered to indicate a signal level, status and/or action required as illustrated in Table 1, below.

TABLE 1

| | LED 2 | | | | |
|---|---|---|---|---|---|
| LED 1 | (2nd | | | | |
| (Bottom | Bottom | Signal | Signal | Signal | |
| Green | Green | Level | Level | Level | |
| LED) | LED) | (CSQ) | [dBm] | Status | Action Required |
| OFF | OFF | 0-4 | −108.8 to | bad | Check all antenna |
| | | | −103 | | connections. Confirm |
| | | | | | wireless service is active |
| | | | | | in area. |
| | | | | | Relocate Panel. |
| FLASHING | OFF | 5-6 | −102 to | weak | If the SIM is active, |
| | | | −99 | | connect a battery to the |
| | | | | | unit and test various |
| | | | | | locations for |
| | | | | | good/excellent signal |
| | | | | | strength |
| ON | OFF | 7-13 | −98 to −85 | good | Location is OK. Signal |
| | | | | | Strength is greater than |
| | | | | | CSQ 7 |
| ON | ON | 14+ | −84 and | excellent | Location is OK. Signal |
| | | | higher | | Strength is greater than |
| | | | | | CSQ 7 |

Further, in one or more embodiments, the one or more LEDs may be different colors and/or capable of changing color, where different colors indicate a different status and/or configuration of premises device 12.

In one or more embodiments, media output element 18 includes at least one audio output element such as a speaker configured to be triggered in a predefined manner by premises device 12 based on at least one of a status, configuration and operation of the premises device 12. In one or more embodiments, media output element 18 includes at least one display, e.g., LED or LCD display, configured to display predefined text in a predefined manner based on at least one of a status, configuration and operation of the premises device 12. For example, the predefined text may be limited to a specific number of characters and/or phrases due to the limited storage space of the memory (not shown) of premises device 12. In one or more embodiments, media output element 18 may include other audio and/or visual outputs know in the art that are capable of being captured by capture device 16, discussed below.

Capture device 16 includes transmitter circuitry 20 and receiver circuitry 22 for communicating with one or more entities. In one embodiment, capture device 16 is configured to communicate with premises device 12 via one or more wireless protocols such as one or more of BLUETOOTH, ZigBee, Z-Wave, Wi-Fi, and cellular protocols. Capture device 16 includes capture element 24. Capture element 24 includes at least one of a camera, image sensor, microphone, image capture element, video capture element, among other devices configured to capture at least one of video, images and audio. Capture device 16 includes output element 26 that is configured to output a translation of the captured media that is captured from premises device 12. In one or more embodiments, output element 26 is at least one of a display, speaker, and/or other element that is capable of outputting an audio and/or visual signal.

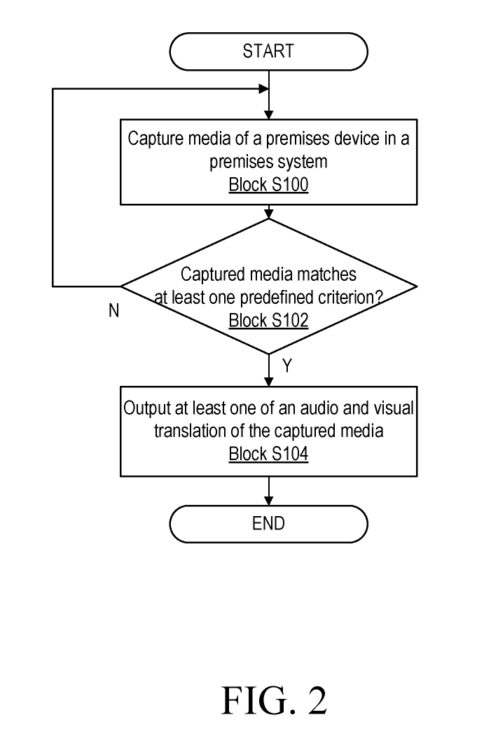

Capture device 16 includes processing circuitry 28. In some embodiments, the processing circuitry 28 may include a processor 30 and memory 32, memory 32 containing instructions which, when executed by processor 30, configure processor 30 to perform the one or more functions described herein such as the process described with respect to FIG. 2. In addition to a traditional processor, e.g., CPU, and memory, processing circuitry 28 may comprise integrated circuitry for processing and/or control, e.g., one or more processors and/or processor cores and/or FPGAs (Field Programmable Gate Array) and/or ASICs (Application Specific Integrated Circuitry).

Processing circuitry 28 may comprise and/or be connected to and/or be configured for accessing (e.g., writing to and/or reading from) memory 32, which may comprise any kind of volatile and/or non-volatile memory, e.g., cache and/or buffer memory and/or RAM (Random Access Memory) and/or ROM (Read-Only Memory) and/or optical memory and/or EPROM (Erasable Programmable Read-Only Memory). Such memory 32 may be configured to store code executable by control circuitry and/or other data, e.g., data pertaining to communication, alarm conditions, tables for translations, etc. Processing circuitry 28 may be configured to control any of the methods described herein and/or to cause such methods to be performed, e.g., by processor 30.

Corresponding instructions may be stored in the memory 32, which may be readable and/or readably connected to the processing circuitry 28. In other words, processing circuitry 28 may include a controller, which may comprise a microprocessor and/or microcontroller and/or FPGA (Field-Programmable Gate Array) device and/or ASIC (Application Specific Integrated Circuit) device. It may be considered that processing circuitry 28 includes or may be connected or connectable to memory, which may be configured to be accessible for reading and/or writing by the controller and/or processing circuitry 28. Memory 32 is configured to store translation code 34 for performing the translation and display of media that is output from premises device 12 that is described in detail with respect to FIG. 2.

In one or more embodiments, system 10 includes one or more servers 36. Server 36 includes transmitter circuitry 38 and receiver circuitry 40 for communicating with one or more entities. In one embodiment, server 36 is configured to communicate with capture device 16 via a wired or wireless communication network, such as the Internet. In the case of wireless communications, wireless communication protocols include but are not limited to BLUETOOTH, ZigBee, Z-Wave, Wi-Fi, and cellular protocols.

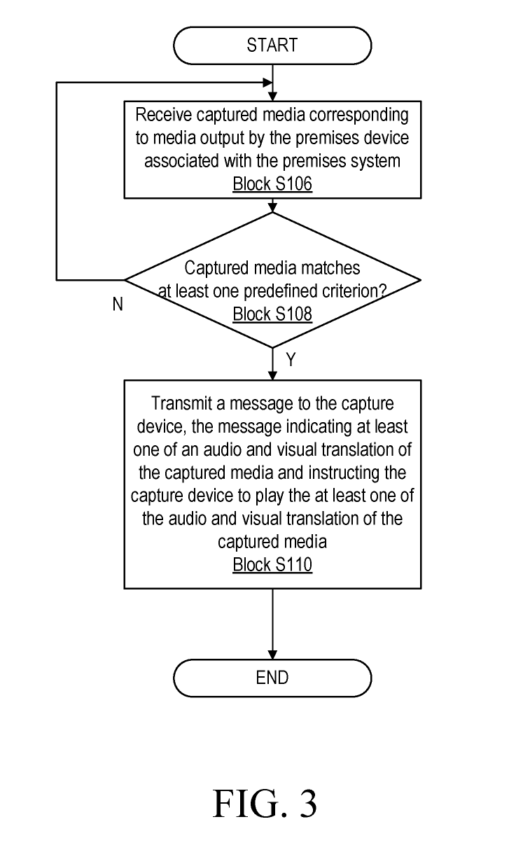

Server 36 includes processing circuitry 42. In some embodiments, the processing circuitry 42 may include a processor 44 and memory 46, memory 46 containing instructions which, when executed by processor 44, configure processor 44 to perform the one or more functions described herein such as the process described with respect to FIG. 3. In addition to a traditional processor and memory, processing circuitry 42 may comprise integrated circuitry for processing and/or control, e.g., one or more processors and/or processor cores and/or FPGAs (Field Programmable Gate Array) and/or ASICs (Application Specific Integrated Circuitry).

Processing circuitry 42 may comprise and/or be connected to and/or be configured for accessing (e.g., writing to and/or reading from) memory 46, which may comprise any kind of volatile and/or non-volatile memory, e.g., cache and/or buffer memory and/or RAM (Random Access Memory) and/or ROM (Read-Only Memory) and/or optical memory and/or EPROM (Erasable Programmable Read-Only Memory). Such memory 46 may be configured to store code executable by control circuitry and/or other data, e.g., data pertaining to communication, alarm conditions, tables for translations, etc. Processing circuitry 42 may be configured to control any of the methods described herein and/or to cause such methods to be performed, e.g., by processor 44.

Corresponding instructions may be stored in the memory 46, which may be readable and/or readably connected to the processing circuitry 42. In other words, processing circuitry 42 may include a controller, which may comprise a microprocessor and/or microcontroller and/or FPGA (Field-Programmable Gate Array) device and/or ASIC (Application Specific Integrated Circuit) device. It may be considered that processing circuitry 42 includes or may be connected or connectable to memory, which may be configured to be accessible for reading and/or writing by the controller and/or processing circuitry 42. Memory 46 is configured to store analysis code 48 for performing the analysis of captured media that is described in detail with respect to FIG. 3. In one or more embodiments, server 36 is omitted from system 10 such as if capture device 16 is performing the analysis as described in FIG. 2.

FIG. 2 is a flow diagram of an exemplary translation process of translation code 34 in accordance with the principles of the invention. In this embodiment, a user holds capture device 16 up to premises device 12 to capture audio, an LED pattern and/or other media output by premises device 12. For example, capture device 16 may have a software application or “app” installed that a user may activate initiate the capture. The software application may be installed capture device 16 such as a smart device, mobile device, etc. with an operating system, e.g., WINDOWS, APPLE IoS, ANDRIOD, etc.

Processing circuitry 28 is configured to capture media output by premises device 12 in a premises system (Block S100). In one or more embodiments, the captured media may indicate at least one of a status and diagnostic information associated with the premises device 12. For example, processing circuitry 28 may capture video of premises device 12, via capture element 24, where premises device 12 is outputting an ON/OFF sequence of one or more LEDs, i.e., a visual sequence, using media output element 18. In another example, processing circuitry 28 may capture audio of premises device 12, via capture element 24, where premises device 12 is outputting an audio sequence of beeps using media output element 18. For example, the one or more LEDs may provide one or more visual sequences that may be translated individually and/or in combination, as discussed herein. In one or more embodiments, processing circuitry 28 may capture, via capture element 24, audio and/or visual data from premises device 12 that is output by media output element 18 of premises device 12.

Processing circuitry 28 determines whether the captured media matches at least one predefined criterion (Block S102). In one or more embodiment, the captured media may be processed using known techniques such as image, video and/or audio processing techniques. The results may be compared with at least one predefined criterion stored in memory 32. The processing of the captured media indicates, for example, color, blinking time and pattern, among other attributes of the captured media that may be used for comparison to at least one predefined criterion. The predefined criterion may include values stored in a table, predefined data, histogram and/or other predefined data that is comparable to captured media and/or the processed captured media. For example, video and/or images of two flashes of an LED may be captured by capture element 24 in which processing circuitry 28 may processes the video and/or 1images, and compares the processed to video and/or images to various stored criterion to find a match, i.e., one stored criterion may indicate two flashes of an LED indicates a low battery while another stored criterion indicates three flashes signifies a wireless network problem.

If the captured media does not match at least one predefined criterion, processing circuitry may repeat the determination of Block S100. Alternatively, the process of FIG. 2 may end. If the captured media matches at least one predefined criterion, processing circuitry 28 outputs at least one of an audio and visual translation of the captured media (Block S104). For example, using the LED example above, if the captured media of one LED flash or a sequence of single flashes match a predefined criterion such as by table lookup via TABLE 2 (below), processing circuitry 28 may output a “low battery” text on output element 26, e.g., display, of capture device 16 and/or outputs an audio recording of “low battery” via output element 26, e.g., speaker, of capture device 16.

TABLE 2

| Red Light | What the Red Light Status |
|---|---|
| Status | means: Trouble Status |
| One Flash | 3G3070-RF Low Battery |
| Two Flashes | SIM/Radio Trouble |
| Three Flashes | Wireless Network Problem |
| Four Flashes | Insufficient Signal Strength |
| Five Flashes | Configuration Trouble |
| Six Flashes | Receiver Not Available |
| Seven Flashes | DC Supply Trouble |

In other words, output element 26 may output at least one of an audio and visual version of textual information such as the wording in one of the rows of “What it means: Trouble Status” or diagnostic information, of TABLE 2 if the capture media corresponds to one of the rows of “Red Light Status” of TABLE 2. In another example, TABLE 1, illustrated above, may also be used in the manner described above where the captured media is determined to match or corresponds to the rows of LED 1 and LED 2 in order to output text or audio of one or more columns.

Another example of using a table for performing Blocks S102 and S104 is illustrated below using TABLE 3.

TABLE 3

| LED | Power LED | Battery LED | Status LED | Network LED | Cellular LED |
|---|---|---|---|---|---|
| Off | No AC | | Not Ready | Not Configured | No Configured |
| | | | | (Comm Path = | Comm Path = |
| | | | | Cellular) | Ethernet |
| Red | | Low Battery | Armed | No Ethernet | No Connection |
| | | 5%/Missing | | Link (No link | (Cellular Status = |
| | | Battery | | status) | searching, not |
| | | | | | registered, |
| | | | | | registration |
| | | | | | denied, unknown) |
| Amber | | Charging | System | Link but Not | Low Signal (Signal |
| | | | Trouble | Connected to | Strength = −100 |
| | | | (security | Alarm | dBm or worst) |
| | | | troubles) | Receiver (No | |
| | | | | supervision | |
| | | | | ACK) | |
| Green | AC | Battery 100% | Ready | Ethernet Link | Good Signal (Signal |
| | | | | (Link status) | Strength = better |
| | | | | | than −95 dBm) |
| Flashing Green | | | Device | | |
| 1 Hz | | | Trouble - | | |
| | | | Can Arm | | |
| | | | (5800 sensors, | | |
| | | | keypads) | | |
| Flashing Amber | | | Device | | Cell but No Data |
| 1 Hz | | | Trouble - | | (Cellular Data |
| | | | Cannot Arm | | Capability = no) |
| | | | (5800 sensors, | | |
| | | | keypads) | | |
| Flashing Red | | Low Battery | Alarm/Alarm | | |
| 1 Hz | | 20% (system | Memory | | |
| | | low battery) | | | |
| Alternating Flashing | | In | In | In | In |
| 1 Hz | | Programming - | Programming - | Programming - | Programming - |
| | | Red | Off | Green | Off |

For example, if processing circuitry 28 determines that the captured media indicates “Cellular LED” of premises device 12 is flashing Amber at 1 Hz, i.e., flashing Amber at a sequence rate of 1 Hz, such as processing captured media using known processing methods, then processing circuitry 28 outputs an audio and/or visual message, via output element 26, of “Cell but No Data (Cellular Data Capability=no)” or another message indicating there is no cellular capability.

In one or more embodiments, one or more tables may correspond to a specific premises device 12 such that capture device 16 may prompt user to identify the premises device 12 and/or capture an image of an identification number of premise device 12 such as a serial number so capture device 16 can identify the premises device 12. In one or more embodiments, capture device 16 is configured to transmit the captured media and/or matching predetermined criterion to a third party for further assistance to the user. Translation code 34 may be an application that may be downloaded to capture device 16, e.g., mobile capture device 16.

While capture device 16 is discussed as performing the process of FIG. 2, one or more steps may be performed by a server (not shown) in communication with capture device 16. For example, capture device 16 may capture the media output by premises device 12 and may transmit the captured media to the server operated by the service provider for processing. The server 36 may respond to capture device 16 with an indication of an audio and/or visual message, i.e., the decoded result, to output via output element 26. It is also note that the details provided in Tables 1, 2 and 3 are only examples. It is understood that other status indicators can be used and that other indicator patterns, colors, etc., can be used to indicate the listed events, alerts, statuses, etc.

FIG. 3 is an exemplary analysis process of analysis code 48 in accordance with the principles of the invention. Processing circuitry 42 receives captured media corresponding to media output by premises device 12 associated with the premises system (Block S106). For example, capture device 16 may capture media output by premises device 12 as described above with respect to Block S100 in which capture device 16 may transmit the captured media or a version of the captured media to server 36 for analysis. In one or more embodiments, the captured media may indicate at least one of a status and diagnostic information associated with the premises device. Processing circuitry 42 determines whether the captured media matches at least one predefined criterion (Block S108). Block S108 corresponds to Block S102 except that the determination is being performed at server 36. If the captured media does not match at least one predefined criterion, processing circuitry 42 may repeat Block S106. Alternatively, the process of FIG. 3 may end. If the captured media matches at least one predefined criterion, processing circuitry 42 transmits a message to capture device 16 (Block S110). In one or more embodiments, the message may indicate at least one of an audio and visual translation of the captured media and may instruct capture device 16 to play the at least one of the audio and visual translation of the captured media. For example, the message may cause capture device 16 to outputs at least one of an audio and visual translation of the captured media as described in Block S104.

As will be appreciated by one of skill in the art, the concepts described herein may be embodied as a method, device and system. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a non-transitory tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the disclosure is not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A device for translating captured media of a premises device, the device comprising:
processing circuitry configured to:
capture media of a premises device in the premises system, the captured media indicating at least one of a status and diagnostic information associated with the premises device; and
if the captured media matches at least one predefined criterion, output at least one of an audio and visual translation of the captured media.

2. The device of claim 1, wherein the at least one predefined criterion is at least one of a media sequence and media pattern.

3. The device of claim 2, wherein the media sequence is generated by a light emitting diode (LED) of the premises device.

4. The device of claim 1, wherein the captured media corresponds to a plurality of visual sequences emitted by the premises device; and
the output of at least one of the audio and visual translation of the captured media including respective translations for each of the plurality of visual sequences.

5. The device of claim 1, wherein the captured media corresponds to a plurality of visual sequences emitted by the premises device; and
the output of at least one of the audio and visual translation of the captured media including a translation based on the plurality of visual sequences.

6. The device of claim 1, wherein the visual translation includes textual information based at least in part on at least one of the status and diagnostic information that is indicated in the captured media.

7. The device of claim 1, wherein the visual translation includes troubleshooting information based at least in part on at least one of the status and diagnostic information that is indicated in the captured media.

8. The device of claim 1, wherein the premises system is a premises security system and the premises device is a device used for monitoring a premises associated with the premises security system.

9. The device of claim 1, wherein the output of at least one of audio translation and visual translation of the captured media includes at least one of displaying the visual translation on a display of the device and outputting the audio translation via a speaker of the device.

10. A method for a device for translating captured media of a premises device, the method comprising:
capturing media of a premises device in the premises system, the captured media indicating at least one of a status and diagnostic information associated with the premises device; and
if the captured media matches at least one predefined criterion, outputting at least one of an audio and visual translation of the captured media.

11. The method of claim 10, wherein the at least one predefined criterion is at least one of a media sequence and media pattern.

12. The method of claim 11, wherein the media sequence is generated by a light emitting diode (LED) of the premises device.

13. The method of claim 10, wherein the captured media corresponds to a plurality of visual sequences emitted by the premises device; and
the output of at least one of the audio and visual translation of the captured media including respective translations for each of the plurality of visual sequences.

14. The method of claim 10, wherein the captured media corresponds to a plurality of visual sequences emitted by the premises device; and
the output of at least one of the audio and visual translation of the captured media including a translation based on the plurality of visual sequences.

15. The method of claim 10, wherein the visual translation includes textual information based at least in part on at least one of the status and diagnostic information that is indicated in the captured media.

16. The method of claim 10, wherein the visual translation includes troubleshooting information based at least in part on at least one of the status and diagnostic information that is indicated in the captured media.

17. The method of claim 10, wherein the premises system is a premises security system and the premises device is a device used for monitoring a premises associated with the premises security system.

18. The method of claim 10, wherein the output of at least one of audio translation and visual translation of the captured media includes at least one of displaying the visual translation on a display of the device and outputting the audio translation via a speaker of the device.

19. A server for translating captured media of a premises device, the server comprising:
processing circuitry configured to:
receive captured media corresponding to media output by the premises device associated with the premises system, the captured media being captured by a capture device and indicating at least one of a status and diagnostic information associated with the premises device;
if the captured media matches at least one predefined criterion, transmit a message to the capture device, the message indicating at least one of an audio and visual translation of the captured media and instructing the capture device to play the at least one of the audio and visual translation of the captured media.

20. The server of claim 19, wherein the at least one predefined criterion is at least one of a media sequence and media pattern.
